(19) United States
(12) Patent Application Publication
(10) Pub. No.: US 2012/0259861 A1
(43) Pub. Date: Oct. 11, 2012

(54) METHOD AND APPARATUS FOR STORING AND SEARCHING FOR INDEX INFORMATION

(75) Inventors: Hao GONG, Shenzhen (CN); Guangyu SHI, Santa Clara, CA (US)

(73) Assignee: HUAWEI TECHNOLOGIES CO., LTD., Shenzhen (CN)

(21) Appl. No.: 13/530,628

(22) Filed: Jun. 22, 2012

Related U.S. Application Data
(63) Continuation of application No. PCT/CN2011/070008, filed on Jan. 4, 2011.

(30) Foreign Application Priority Data
Apr. 23, 2010 (CN) 201010155688.2

(51) Int. Cl. G06F 17/30

(52) U.S. Cl. 707/741; 707/770; 707/E17.002; 707/E17.014

(57) ABSTRACT

The present invention discloses a method for storing index information. The method includes: after storing a content, sending index information pointing to the stored content to index nodes in an aggregation network that belong to the same geographical area as the stored content for storing; and sending the index information pointing to the stored content to index nodes in a core network for storing. The present invention also discloses a method for searching for index information, an apparatus for storing index information, an apparatus for searching for index information, and a communication network system.

### CROSS-REFERENCE TO RELATED APPLICATIONS

This application is a continuation of International Application No. PCT/CN2011/070008, filed on Jan. 4, 2011, which claims priority to Chinese Patent Application No. 201010155688.2, filed on Apr. 23, 2010, both of which are hereby incorporated by reference in their entireties.

### FIELD OF THE INVENTION

The present invention relates to the field of communications technologies, and in particular, to a method and an apparatus for storing and searching for index information.

### BACKGROUND OF THE INVENTION

In a conventional distributed object-based storing system, the specific storing location of each object is saved in an index file, and these index files are stored in one or more index servers. In actual deployment, these index servers managing the index information are located at the same level in terms of physical location, and a flat architecture is formed among the index servers.

In an actually deployed network, how to ensure efficient access to the index information is one of the important problems that the conventional index servers face. On the other hand, how to solve the flash crowd (Flash Crowd) phenomenon that occurs when a large number of users simultaneously flood into the system to access a single index (index nodes become a bottleneck of the system) is another important problem that needs to be solved urgently in a complete index system.

The prior art proposes a CoralCDN (Content Distributed Network, content distributed network) technology. The technology is proposed to solve the problem of efficiently and quickly distributing contents in a conventional network, and is especially to use the effective spread and quick search technologies of the Coral algorithm in content indexes to solve the problem of flash crowds commonly found in the conventional network.

In the CoralCDN technology, the DHT (Distributed Hash Table, distributed hash table) method is used for storing index data. In each operation, the final index node is found by means of multiple hops according to a rule corresponding to a key-value (key-value). Furthermore, in order to solve the flash crowd problem, the index information is spread and stored into index nodes located on a search path. In this way, for an index of a hot resource, multiple index nodes simultaneously in the network may provide an access service to the hot resource, thereby reducing the load overhead of a single node.

When implementing the present invention, the inventor finds that the prior art has at least the following disadvantages:

1. In the Coral, an index can be spread to improve multi-point access and backup, but for the index information after the spread, because of the special index registration mechanism of the index information, each node may only store a part of the index information, so that no node stores an overall index information list, and it is impossible to obtain a complete information status.

2. The Coral spreads the index information to various nodes on the search path by means of multiple hops, so as to reduce the load overhead of the root node, but the multi-hop search method means that the delay of each search may be increased as the number of hops increases, thereby affecting search efficiency.

3. In the Coral, after each leaf node caches certain index information, the index information on the root node may not be accessed by users, so that the utilization of the index information on the root node is very low.

4. In the Coral, although the concept of geographical area is introduced in the multi-hop access of indexes, the index content data stored in each node is not divided by geographical area. Such index results obtained when geographical area is not divided are disadvantageous for implementing traffic balancing and traffic localization.

### SUMMARY OF THE INVENTION

An embodiment of the present invention provides a method for storing index information to effectively obtain a complete index information status of all contents, which is advantageous for implementing traffic balancing and traffic localization. The method includes:

after storing a content, sending index information pointing to the stored content to index nodes in an aggregation network that belong to the same geographical area as the stored content for storing; and

sending the index information pointing to the stored content to index nodes in a core network for storing.

An embodiment of the present invention further provides a method for searching for index information, to improve index search efficiency and improve utilization of index information on index nodes in a core network. The method includes:

receiving a request from a user for accessing a content;

searching index nodes in an access network for index information pointing to the content to be accessed;

if the index information is not found, searching index nodes in an aggregation network for the index information pointing to the content to be accessed; and

if the index information is still not found, searching index nodes in a core network for the index information pointing to the content to be accessed.

An embodiment of the present invention further provides an apparatus for storing index information, to effectively obtain a complete index information status of all contents, which is advantageous for implementing traffic balancing and traffic localization. The apparatus includes:

a first storing module, configured to, after storing a content, send index information pointing to the stored content to index nodes in an aggregation network that belong to the same geographical area as the stored content for storing; and

a second storing module, configured to send the index information pointing to the stored content to index nodes in a core network for storing.

An embodiment of the present invention further provides an apparatus for searching for index information, to improve index search efficiency and improve utilization of index information on index nodes in a core network. The apparatus includes:

a receiving module, configured to receive a request from a user for accessing a content;

a first searching module, configured to search index nodes in an access network for index information pointing to the content to be accessed;

a second searching module, configured to, when the first searching module does not find the index information pointing to the content to be accessed, search index nodes in an aggregation network for the index information pointing to the content to be accessed; and a third searching module, configured to, when the second searching module still does not find the index information pointing to the content to be accessed, search index nodes in a core network for the index information pointing to the content to be accessed.

An embodiment of the present invention further provides a communication network system for effectively obtaining a complete index information status of all contents, which is advantageous for implementing traffic balancing and traffic localization. The system includes:

index nodes in an aggregation network, where index nodes belonging to the same geographical area as a stored content are configured to store index information pointing to the stored content after storing the content; and index nodes in a core network, configured to store the index information pointing to the stored content.

In the embodiments of the present invention, after the content is stored, the index information pointing to the stored content is sent to the index nodes in the aggregation network that belong to the same geographical area as the stored content for storing; the index information pointing to the stored content is sent to the index nodes in the core network for storing, where the index nodes in the core network may store the index information of all contents for effectively obtaining the complete index information status of all contents; the index information stored by the index nodes in the aggregation network is divided by geographical area, and such geographically divided index results are advantageous for implementing traffic balancing and traffic localization.

In the embodiments of the present invention, the request from the user for accessing the content is received; the index nodes in the access network are searched for the index information pointing to the content to be accessed; if the index information is not found, the index nodes in the aggregation network are searched for the index information pointing to the content to be accessed; if the index information is still not found, the index nodes in the core network are searched for the index information pointing to the content to be accessed, so that the index search efficiency may be improved, and by means of one-hop search, the network transmission delay caused by the multi-hop search in the prior art is significantly decreased; the load frequency of the index nodes in the core network is reduced and the impact of the flash crowd phenomenon on the index nodes is avoided, and meanwhile, the index nodes in the core network may also be accessed by a user, thereby relatively improving the utilization of the index information on the index nodes in the core network.

### BRIEF DESCRIPTION OF THE DRAWINGS

To make the technical solutions of the embodiments of the present invention or the prior art clearer, the accompanying drawings for describing the embodiments or the prior art are briefly described hereunder. Evidently, the accompanying drawings illustrate only some embodiments of the present invention, and persons of ordinary skill in the art can obtain other drawings based on these drawings without creative efforts. In the accompanying drawings:

FIG. 1 is a process flowchart of a method for storing index information according to an embodiment of the present invention;

FIG. 2 is a schematic diagram of a network topology of an implementation scenario of a method for storing index information according to an embodiment of the present invention;

FIG. 3 is a schematic division diagram of the network topology shown in FIG. 2 according to an embodiment of the present invention;

FIG. 4 is a process flowchart of a method for searching for index information according to an embodiment of the present invention;

FIG. 5 is a schematic structural diagram of an apparatus for storing index information according to an embodiment of the present invention;

FIG. 6 and FIG. 7 are schematic structural diagrams of specific examples of an apparatus for storing index information according to embodiments of the present invention;

FIG. 8 is a schematic structural diagram of an apparatus for searching for index information according to an embodiment of the present invention;

FIG. 9, FIG. 10, and FIG. 11 are schematic structural diagrams of specific examples of an apparatus for searching for index information according to embodiments of the present invention; and

FIG. 12 is a schematic structural diagram of a communication network system according to an embodiment of the present invention.

### DETAILED DESCRIPTION OF THE EMBODIMENTS

To make the objectives, technical solutions, and advantages of the embodiments of the present invention clearer, the embodiments of the present invention are hereinafter described in detail with reference to the accompanying drawings. Here, the exemplary embodiments of the present invention and the description of the embodiments of the present invention are intended to explain the present invention, but cannot be construed as a limitation on the present invention.

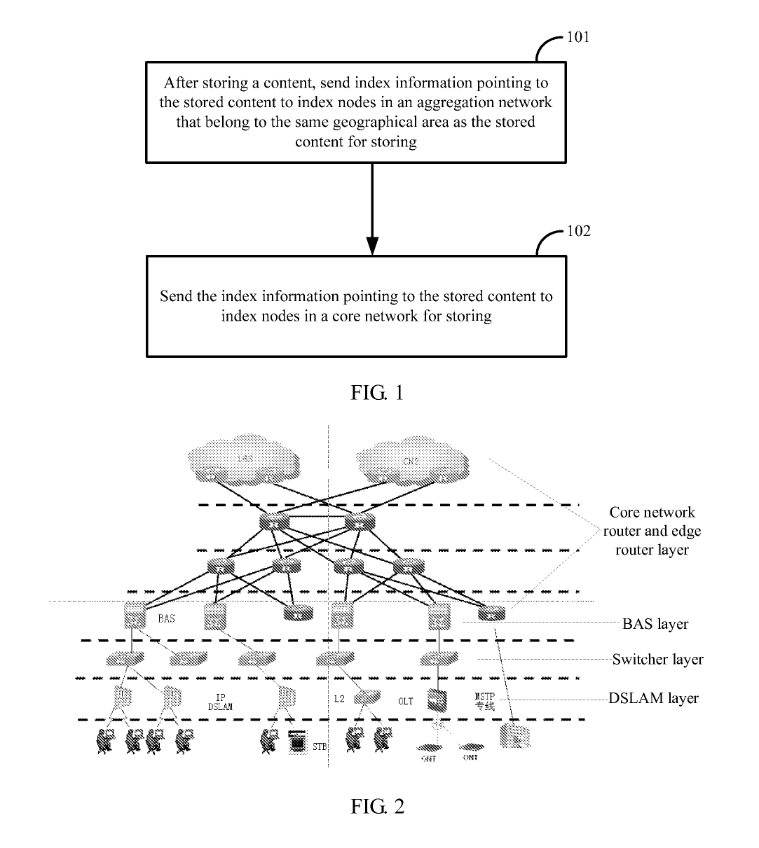

As shown in FIG. 1, in an embodiment of the present invention, the process flow of a method for storing index information may include:

Step 101: After storing a content, send index information pointing to the stored content to index nodes in an aggregation network that belong to the same geographical area as the stored content for storing.

Step 102: Send the index information pointing to the stored content to index nodes in a core network for storing.

As can be known from the process shown in FIG. 1, in this embodiment of the present invention, after the content is stored, the index information pointing to the stored content is sent to the index nodes in the aggregation network that belong to the same geographical area as the stored content for storing; the index information pointing to the stored content is sent to the index nodes in the core network for storing, where the index nodes in the core network may store the index information of all contents for effectively obtaining the complete index information status of all contents; the index information stored by the index nodes in the aggregation network is divided by geographical area, and such geographically divided index results are advantageous for implementing traffic balancing and traffic localization.

In order to clearly illustrate the specific implementation of the process shown in FIG. 1, an example is described for illustration hereinafter. The implementation scenario of this example is shown in the schematic diagram of the network topology as shown in FIG. 2. Other implementation scenarios of the embodiments of the present invention are similar to that shown in FIG. 2. Generally, a network may be divided into four layers: a core router and edge router layer, a BAS (Broadband Access Server) layer, a Switcher (switcher) layer, and a bottom DSLAM (Digital Subscriber Line Access Multiplexer, digital subscriber line access multiplexer) layer. As can also be seen from the connection relationship in FIG. 2, the connection relationship between the layers is basically layer-by-layer aggregation and level-by-level convergence. Therefore, it can be considered to use such a convergence ratio between the layers to implement rational storing and quick search of the index information.

Therefore, the inventor considers providing a layered index management method according to the process as shown in FIG. 1. According to the layered architecture of the network, upper-layer nodes in the network are used as a distributed index layer, and in addition, a subnet index proxy layer and a local index proxy layer are set to improve efficiency in accessing indexes and avoid the flash crowd problem.

According to the network topology, the inventor proposes to use devices in the core network as index nodes, such as devices in the BAS layer in the network as shown in FIG. 2, to form a distributed index layer storing index information of all contents. In this way, it is assumed that the whole distributed index layer has 160 index nodes, each node is provided with 1 GB memory for storing index data, and it is further assumed that the index information of a Cache (cache) list of each content resource is approximately 500 bytes, the 160 devices in total can store approximately 160*1 GB/500 bytes/3=0.1 billion indexes, and such a size is sufficient to meet the demand for storing the index information of hot content resources.

The nodes in the local index proxy layer are proxy nodes that are closest to users, and the inventor proposes to use devices in an access network as index nodes, such as devices in the DSLAM layer in the network as shown in FIG. 2.

The nodes in the subnet index proxy layer are nodes in the layer above the local index proxy layer, and the inventor proposes to use devices in the aggregation network as index nodes, such as devices in the Switcher layer in the network as shown in FIG. 2, for storing the index information that belongs to the same geographical area as the content, to form an index information list Up Proxy Table in the geographical area of a current subnet, thereby achieving the effect of converging user requests in the same subnet and traffic localization. For example, the Switcher devices under the same router cache the index information of contents that are located in the geographical area of their subnet in a current network. For example, according to the convergence of the devices in the network topology diagram as shown in FIG. 2, the convergence ratio between the Router and the Switcher is approximately 1:30 (each Switcher is connected to two Routers simultaneously), that is, whenever a Cache is formed, it is required to register the index information with the Switcher that is governed by the same Router. In this way, each Switcher may also have the function of a proxy, further converge user requests in different geographical areas, and improve the index search efficiency. Meanwhile, all the index data information cached in the subnet index proxy layer is located in Cache lists under the same subnet, which is very helpful to the effect of local optimization at a subnet level. Evidently, the subsequent data request behaviors of a user are also limited to one subnet, thereby achieving the effect of traffic localization.

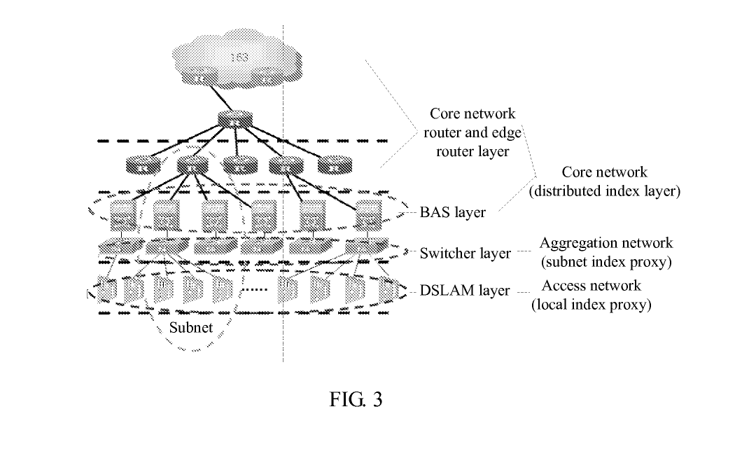

According to the foregoing embodiment, the division of the hierarchy of a network for storing index information is as shown in FIG. 3. Under this hierarchy, the process as shown in FIG. 1 may specifically be implemented as the following process for registering index information:

When a bottom-layer storing node caches a content fragment, the node starts to register cache information pointing to the stored content with the index nodes, that is, implements step 101 and step 102.

An embodiment of step 101 includes: sending, by a storing node, a PUT (put) request to an index node in the subnet index proxy layer above the storing node, where the PUT request carries the index information pointing to the stored content, such as a Hash (hash) value of the content; an IP address of the storing node may also be carried during implementation. The sending of the PUT request in this example is exemplary only, and during specific implementation, the sending of the index information may also be implemented by other means of sending. After receiving the PUT request, the index node in the upper subnet index proxy layer adds or updates an index information entry of the content fragment in a cache table (Up Proxy Table), and adds the new Cache to the table.

An embodiment of step 102 includes: after adding the new Cache to the table, continuing, by the index node in the upper subnet index proxy layer, to forward the PUT request upward according to a one-hop routing table. After selecting a correct index node according to the one-hop routing table to receive the PUT request, an upper layer, namely, the distributed index layer, adds the Cache information to an index information cache table (Index Level), thereby achieving an index registration process.

In specific implementation, step 101 may further include: after adding the Cache information to the index information cache table (Index Level), broadcasting, by an index node in the distributed index layer, the information to other index nodes in the subnet index proxy layer that are located in the same subnet as the registered storing node, to enable the nodes to write the information into cache tables (Up Proxy Tables). In this way, all the index nodes in the aggregation network that belong to the same geographical area as the stored content store the index information pointing to the stored content.

In an embodiment, when being implemented, the process as shown in FIG. 1 may further include: sending the index information pointing to the stored content to the index nodes in the access network that belong to the same geographical area as the stored content for storing, so that the index nodes in the local index proxy layer may also maintain an index information list (Proxy Table), and achieve the effect of converging and aggregating lower-layer user requests, thereby achieving the effect of better traffic balancing and traffic localization.

In an embodiment, when being implemented, the process as shown in FIG. 1 may further include: collecting statistics about access behaviors of a user, and storing, on the index nodes in the access network and/or the aggregation network, index information pointing to contents that have been accessed by the user. For example, the index nodes in the local index proxy layer may cache Cache list information that is previously requested within one minute in the maintained index information list Proxy Table, so that during the time period, if another user requests the same resource fragment, the information recorded in the Proxy Table may be returned directly. Evidently, the index nodes in the local index proxy layer may also periodically collect access history information of the user, such as performing periodic TTL (Time To Live, time to live) maintenance on the Proxy Table, and respond uniformly to users' access requests, to achieve the effect of converging and aggregating lower-layer user requests. The specific implementation of the index nodes in the subnet index proxy layer is similar, and the index nodes may also cache, in the Up Proxy Table, the index information of contents in the geographical area of a current subnet that have been accessed by the user. In this way, the index information may be searched for more conveniently, thereby further improving the effect of traffic balancing and traffic localization.

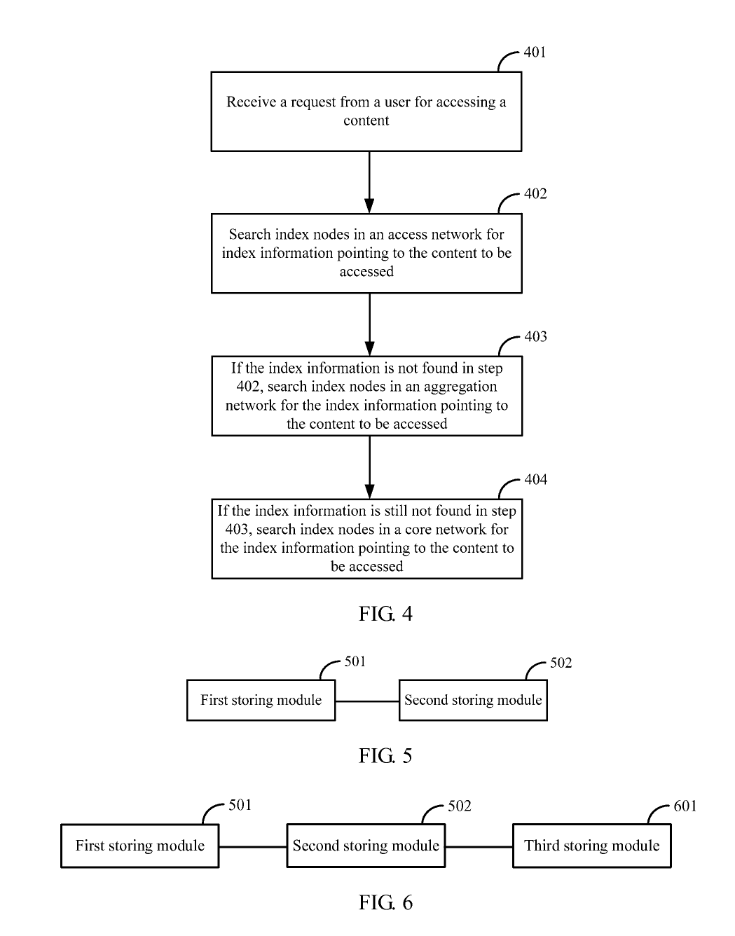

As shown in FIG. 4, an embodiment of the present invention further provides a method for searching for index information. The index information searched for in this search method may be stored according to the storing method in the foregoing embodiment. The search method may include:

Step 401: Receive a request from a user for accessing a content.

Step 402: Search index nodes in an access network for index information pointing to the content to be accessed.

Step 403: If the index information is not found in step 402, search index nodes in an aggregation network for the index information pointing to the content to be accessed.

Step 404: If the index information is still not found in step 403, search index nodes in a core network for the index information pointing to the content to be accessed.

As can be known from the process shown in FIG. 4, in this embodiment of the present invention, the request from the user for accessing the content is received; the index nodes in the access network are searched for the index information pointing to the content to be accessed; if the index information is not found, the index nodes in the aggregation network are searched for the index information pointing to the content to be accessed; if the index information is still not found, the index nodes in the core network are searched for the index information pointing to the content to be accessed, so that the index search efficiency may be improved, and by means of one-hop search, the network transmission delay caused by the multi-hop search in the prior art is significantly decreased; the load frequency of the index nodes in the core network is reduced and the impact caused by the flash crowd phenomenon on the index nodes is avoided, and meanwhile, the index nodes in the core network may also be accessed by the user, thereby relatively improving the utilization of the index information on the index nodes in the core network. After the index information pointing to the content to be accessed is found by using the method as shown in FIG. 4, a corresponding content may be obtained according to the found index information pointing to the content to be accessed, and may be provided to the user.

In specific implementation, the index nodes in the access network and/or the aggregation network may store the index information pointing to contents that have been accessed by the user. For example, in the specific implementation, when the user requests a certain content fragment, the request is firstly sent to an index node in the access network, that is, the request is firstly sent to an index node in a local index proxy layer accessed by the user. After receiving the request, the index node in the local index proxy layer firstly searches an index table (Proxy Table) cached by the index node itself to check whether index information of the content fragment exists, for example, whether other users have requested the index information of the content fragment within the previous time of Timer1 (this time may be configured). If the index information of the content fragment exists, the index information in the Cache list is directly returned to the user; if the index information of the content fragment does not exist, the request is sent to an index node in the aggregation network, that is, an index node in an upper subnet index proxy layer. After receiving the request, the index node in the upper subnet index proxy layer searches its own cache table (Up Proxy Table) to check whether a corresponding Cache index information content exists in a current subnet. If the corresponding Cache index information content exists in the current subnet, the result is directly returned to the user; if the corresponding Cache index information content does not exist in the current subnet, a complete Cache list is searched on the index nodes in the core network, that is, on the index nodes in an upper distributed index layer (Index Level), according to a one-hop routing table, until a final result is found and returned to the user.

If a flash crowd scenario occurs at this time, firstly the request of the user is cached within the time of Timer1 by the index node in the local index proxy layer serving as a Proxy; secondly, a Switcher segment in a subnet index proxy layer can further cache certain impact of service requests; and finally, an index root (root) node in a top distributed index layer (Index Level) is searched only when the service request of the user is not found in the current subnet, and at this time, the load of the node has been reduced to a very low level and it is sufficient to solve the flash crowd problem.

In an embodiment, if the index information pointing to the content to be accessed is found on the index nodes in the aggregation network, the process as shown in FIG. 4 may further include: storing the index information pointing to the content to be accessed into the index nodes in the access network, so as to facilitate the next search of the index information, thereby further improving search efficiency and decreasing network delay.

In an embodiment, if the index information pointing to the content to be accessed is found on the index nodes in the aggregation network, but the number of content entries in the aggregation network that store the index information pointing to the content to be accessed is smaller than a threshold value, the process as shown in FIG. 4 may further include: searching the index nodes in the core network for the index information pointing to the content to be accessed. For example, after receiving a search request sent by the index node in the local index proxy layer, the index node in the subnet index proxy layer firstly searches its own cache table (Up Proxy Table) to check whether a corresponding Cache index information content exists within the current subnet and meanwhile, the number of Cache index information content entries meets the minimum set threshold (Cache Number Threshold); if the corresponding Cache index information content exists, the result is directly returned to the user; if no corresponding Cache index information content exists or the number of Cache index information content entries within the same subnet is too small, a complete Cache list is searched on the index nodes in the core network, that is, on the index nodes in an upper distributed index layer (Index Level), until a final result is found and returned to the user. In this way, whether cache index nodes in a local subnet have a sufficient capability to provide the user access service of the local subnet is fully considered, so as to reduce the load overhead of a single index node.

Persons of ordinary skill in the art may understand that all or part of steps in the methods according to the foregoing embodiments may be implemented by a program instructing relevant hardware. The program may be stored in a computer readable storage medium, and when the program is executed, all or part of the steps in the methods according to the foregoing embodiments may be included; and the foregoing storage medium may include a ROM, a RAM, a magnetic disk, and a CD-ROM.

Embodiments of the present invention further provide an apparatus for storing index information, an apparatus for searching for index information, and a communication network system, as described in the following embodiments. Because the principles of the apparatuses and the system in solving problems are similar to the method for storing index information and the method for searching for index information, for the implementation of the apparatuses and the system, reference can be made to the implementation of the methods, and repeated description is omitted herein.

An embodiment of the present invention provides an apparatus for storing index information, the structure of the apparatus is as shown in FIG. 5. The apparatus may include:

a first storing module 501, configured to, after storing a content, send index information pointing to the stored content to index nodes in an aggregation network that belong to the same geographical area as the stored content for storing; and

a second storing module 502, configured to send the index information pointing to the stored content to index nodes in a core network for storing.

As shown in FIG. 6, in an embodiment, the apparatus as shown in FIG. 5 may further include:

a third storing module 601, configured to send the index information pointing to the stored content to index nodes in an access network that belong to the same geographical area as the stored content for storing.

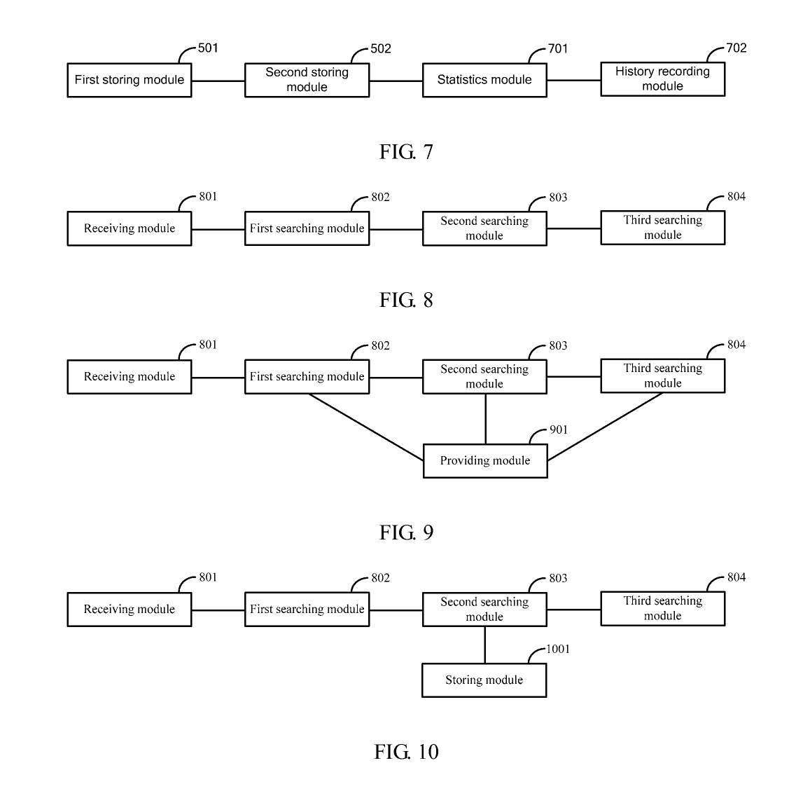

As shown in FIG. 7, in an embodiment, the apparatus as shown in FIG. 5 may further include:

a statistics module 701, configured to collect statistics about access behaviors of a user; and

a history recording module 702, configured to store, on the index nodes in the access network and/or the aggregation network, index information pointing to contents that have been accessed by the user. Evidently, the apparatus as shown in FIG. 6 may further include the statistics module 701 and the history recording module 702.

An embodiment of the present invention further provides an apparatus for searching for index information. The search apparatus may search for the index information stored by the apparatus as shown in FIG. 5. As shown in FIG. 8, the apparatus for searching for index information may include:

a receiving module 801, configured to receive a request from a user for accessing a content;

a first searching module 802, configured to search index nodes in an access network for index information pointing to the content to be accessed;

a second searching module 803, configured to, when the first searching module does not find the index information pointing to the content to be accessed, search index nodes in an aggregation network for the index information pointing to the content to be accessed; and

a third searching module 804, configured to, when the second searching module still does not find the index information pointing to the content to be accessed, search index nodes in a core network for the index information pointing to the content to be accessed.

As shown in FIG. 9, in an embodiment, the apparatus as shown in FIG. 8 may further include:

a providing module 901, configured to obtain a corresponding content according to the found index information pointing to the content to be accessed, and provide the obtained content to the user.

As shown in FIG. 10, in an embodiment, the apparatus as shown in FIG. 8 may further include:

a storing module 1001, configured to, when the second searching module 803 finds the index information, which points to the access content, on the index nodes in the aggregation network, store the index information pointing to the content to be accessed into the index nodes in the access network.

As shown in FIG. 11, in an embodiment, the apparatus as shown in FIG. 10 may further include:

a fourth searching module 1101, configured to search the index nodes in the core network for the index information pointing to the content to be accessed, when the second searching module 803 finds the index information pointing to the access content on the index nodes in the aggregation network but the number of content entries in the aggregation network that store the index information pointing to the content to be accessed is smaller than a threshold value. Evidently, the apparatus as shown in FIG. 8 may further include the fourth searching module 1101.

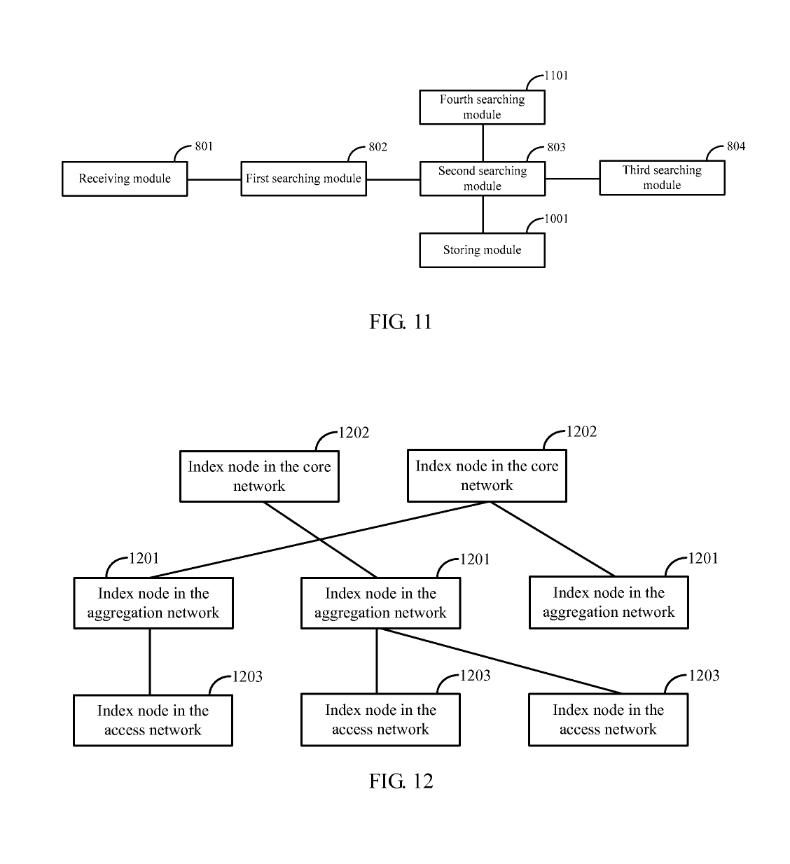

An embodiment of the present invention further provides a communication network system, the structure of the system is as shown in FIG. 12. The system may include:

index nodes 1201 in an aggregation network, where index nodes belonging to the same geographical area as a stored content are configured to store index information pointing to the stored content after storing the content; and

index nodes 1202 in a core network, configured to store the index information pointing to the stored content.

As shown in FIG. 12, in an embodiment, the communication network system as shown in FIG. 12 may further include:

index nodes 1203 in an access network, where index nodes belonging to the same geographical area as the stored content are configured to store the index information pointing to the stored content.

In an embodiment, the index nodes 1203 in the access network may further be configured to: collect statistics about access behaviors of a user, and store index information pointing to contents that have been accessed by the user; and/or

the index nodes 1201 in the aggregation network may further be configured to: collect statistics about access behaviors of a user, and store index information pointing to contents that have been accessed by the user.

In the embodiments of the present invention, after the content is stored, the index information pointing to the stored content is sent to the index nodes in the aggregation network that belong to the same geographical area as the stored content for storing; the index information pointing to the stored content is sent to the index nodes in the core network for storing, where the index nodes in the core network may store the index information of all contents for effectively obtaining a complete index information status of all contents; the index information stored by the index nodes in the aggregation network is divided by geographical area, and such geographically divided index results are advantageous for implementing traffic balancing and traffic localization.

In the embodiments of the present invention, the request from the user for accessing the content is received; the index nodes in the access network are searched for the index information pointing to the content to be accessed; if the index information is not found, the index nodes in the aggregation network are searched for the index information pointing to the content to be accessed; if the index information is still not found, the index nodes in the core network are searched for the index information pointing to the content to be accessed, so that the index search efficiency may be improved, and by means of one-hop search, the network transmission delay caused by the multi-hop search in the prior art is significantly decreased; the load frequency of the index nodes in the core network is reduced and the impact caused by the flash crowd phenomenon on the index nodes is avoided, and meanwhile, the index nodes in the core network may also be accessed by the user, thereby relatively improving the utilization of the index information on the index nodes in the core network.

The foregoing specific embodiments further describe the objectives, technical solutions, and beneficial effects of the present invention in detail. It should be understood that the above description is merely about specific embodiments of the present invention, but not intended to limit the protection scope of the present invention. Any modification, equivalent substitution, improvement, and so on within the idea and the principle of the present invention shall be included in the protection scope of the present invention.

What is claimed is:

1. A method for storing index information, comprising:
after storing a content, sending index information pointing to the stored content to index nodes in an aggregation network that belong to the same geographical area as the stored content for storing; and
sending the index information pointing to the stored content to index nodes in a core network for storing.

2. The method according to claim 1, further comprising:
sending the index information pointing to the stored content to index nodes in an access network that belong to the same geographical area as the stored content for storing.

3. The method according to claim 1, further comprising:
collecting statistics about access behaviors of a user, and storing, on index nodes in an access network and/or the aggregation network, index information pointing to contents that have been accessed by the user.

4. A method for searching for index information, comprising:
receiving a request from a user for accessing a content;
searching index nodes in an access network for index information pointing to the content to be accessed;
if the index information is not found, searching index nodes in an aggregation network for the index information pointing to the content to be accessed; and
if the index information is still not found, searching index nodes in a core network for the index information pointing to the content to be accessed.

5. The method according to claim 4, further comprising:
obtaining a corresponding content according to the found index information pointing to the content to be accessed, and providing the obtained content to the user.

6. The method according to claim 4, wherein if the index information pointing to the content to be accessed is found on the index nodes in the aggregation network, the method further comprises:
storing the index information pointing to the content to be accessed into the index nodes in the access network.

7. The method according to claim 4, wherein if the index information pointing to the content to be accessed is found on the index nodes in the aggregation network, but the number of content entries in the aggregation network that store the index information pointing to the content to be accessed is smaller than a threshold value, the method further comprises:
searching the index nodes in the core network for the index information pointing to the content to be accessed.

8. The method according to claim 4, wherein the index nodes in the access network and/or the aggregation network store index information pointing to contents that have been accessed by the user.

9. An apparatus for storing index information, comprising:
a first storing module, configured to, after storing a content, send index information pointing to the stored content to index nodes in an aggregation network that belong to the same geographical area as the stored content for storing; and
a second storing module, configured to send the index information pointing to the stored content to index nodes in a core network for storing.

10. The apparatus according to claim 9, further comprising:
a third storing module, configured to send the index information pointing to the stored content to index nodes in an access network that belong to the same geographical area as the stored content for storing.

11. The apparatus according to claim 9, further comprising:
a statistics module, configured to collect statistics about access behaviors of a user; and
a history recording module, configured to store, on index nodes in an access network and/or the aggregation network, index information pointing to contents that have been accessed by the user.

12. An apparatus for searching for index information, comprising:
a receiving module, configured to receive a request from a user for accessing a content;
a first searching module, configured to search index nodes in an access network for index information pointing to the content to be accessed;
a second searching module, configured to, when the first searching module does not find the index information pointing to the content to be accessed, search index nodes in an aggregation network for the index information pointing to the content to be accessed; and
a third searching module, configured to, when the second searching module still does not find the index information pointing to the content to be accessed, search index nodes in a core network for the index information pointing to the content to be accessed.

13. The apparatus according to claim 12, further comprising:
a providing module, configured to obtain a corresponding content according to the found index information pointing to the content to be accessed, and provide the obtained content to the user.

14. The apparatus according to claim 12, further comprising:
a storing module, configured to, when the second searching module finds the index information, which points to the access content, on the index nodes in the aggregation network, store the index information pointing to the content to be accessed into the index nodes in the access network.

15. The apparatus according to claim 12, further comprising:
a fourth searching module, configured to search the index nodes in the core network for the index information pointing to the content to be accessed, when the second searching module finds the index information, which points to the access content, on the index nodes in the aggregation network but the number of content entries in the aggregation network that store the index information pointing to the content to be accessed is smaller than a threshold value.

16. The apparatus according to claim 12, wherein the index nodes in the access network and/or the aggregation network store index information pointing to contents that have been accessed by the user.
